(19) United States
(12) Patent Application Publication
(10) Pub. No.: US 2004/0053195 A1
(43) Pub. Date: Mar. 18, 2004

(54) Healing cap and gingival emergence profiler for dental implant anchor

(76) Inventor: Gordon D. Blacklock, Albuquerque, NM (US)

Correspondence Address: Sonya C. Harris, PO Box 2607, Fairfax, VA, 22031, US

(21) Appl. No.: 10/244,400

(22) Filed: Sep. 17, 2002

(51) Int. Cl. A61C 8/00

(52) U.S. Cl. 433/173

(57) ABSTRACT

A healing cap and emergence profiler for a dental implant anchor are disclosed. The healing cap has a cylindrical head having a threaded opening at the top side, and legs projecting downwardly from the head. The threaded opening receives a threaded tool which will subsequently be employed to withdraw the healing cap from the anchor. The legs are separated by a gap enabling the legs to be urged toward one another when the healing cap is inserted into the anchor. The legs of the healing cap fit through an aperture in the emergence profiler such that the profiler surrounds the head of the healing cap and abuts the top of the dental implant anchor, thereby preventing the regeneration of gingival tissue around the shoulder of the anchor and allowing easy modification of the emergence profiler to surrounding gingival tissue. The emergence profiler would typically be of a biocompatible plastic.

### BACKGROUND OF THE INVENTION

This application is related to U.S. patent application, Ser. No. 08/606,004, filed on Feb. 12, 1996, and subsequently issued on Mar. 31, 1998, as U.S. Pat. No. 5,733,123, included herein by reference.

1. Field of the Invention

The present invention relates to a healing cap for an implant anchor for a dental implant. After the implant anchor is implanted in bone tissue of a patient, the healing cap protects the upwardly oriented opening of the implant anchor, which will subsequently receive a post and core assembly, from being obstructed by regenerated gum tissue and other possible contaminants. Additionally, an emergence profiler surrounding the shoulder of the implant anchor and the perimeter of the healing cap prevents gingival tissue growth over the shoulder of the implant anchor, ultimately presenting a more natural appearance when the prosthetic tooth is installed.

2. Description of the Prior Art

When an implant anchor for receiving a post and core assembly of a dental prosthesis is initially installed in a patient's jaw, care must be exercised to ensure that the opening does not become clogged due to regenerated gum tissue or other materials. A temporary sealing member, called a healing cap or cuff, is ordinarily provided for sealing the implant anchor while bone tissue grows around and solidifies the implant anchor in the jaw. Most healing caps thread into the implant anchor, which, typically, has an anti-rotational opening for receiving the post and core. After removal of the healing cap, the threads may also be used to secure the abutment in the final installation.

Additionally, it is desirable to prevent gingival tissue from growing over the shoulder area of the implant anchor. An emergence profiler surrounding the shoulder of the implant anchor the healing cap and held in place by the healing cap prohibits gingival growth around the implant anchor.

An IMPLANT HEALING CAP AND HOLDER is disclosed in U.S. Pat. No. 5,030,096, issued to Steven M. Hurson, et al., on Jul. 9, 1991. This healing cap has an upwardly oriented opening for resiliently receiving a grasping member which can be withdrawn from the cap after installation of the latter in the implant anchor. However, the opening is plain, lacking threading or other structure for the engagement of a tool or key for removing the cap when it is time for removal thereof from the implant anchor. By contrast, the present invention has structure which enables a key or like tool to engage the cap for positive retention during removal. Furthermore, the cap of Hurson, et al., has threads for engaging the opening of the implant anchor, which are absent in the present invention, and lacks the emergence profile of the present invention.

U.S. Pat. Nos. 5,154,612, issued to Lennart Carlsson, et al., on Oct. 13, 1992, and 5,417,570, issued to Max Zuest, et al., on May 23, 1995, both feature caps which lack threads for engaging an implant anchor. However, in both prior art examples, the cap externally surrounds the implant anchor or other part of the implant engaged by the cap. In contrast to this, the novel healing cap penetrates and engages the same opening which will subsequently be employed to receive the post and core of the prosthesis and prohibits gingival growth around the shoulder area of the implant anchor through the addition of an emergence profiler.

A member which penetrates an implant anchor and engages the same by friction is shown in U.S. Pat. No. 5,437,551, issued to Paul R. Chalifoux on Aug. 1, 1995. However, the top of this member is plain, lacking an opening and associated structure for engaging a key or other tool which may be employed to withdraw the member. In contrast to the device of Chalifoux, such an opening and associated structure are found in the present invention and gingival growth around the shoulder area of the implant anchor is prohibited through the addition of an emergence profiler.

None of the above inventions and patents, taken either singly or in combination, is seen to describe the instant invention as claimed.

### SUMMARY OF THE INVENTION

The present invention allows easy temporary covering of the top of the implant anchor without the danger of dropping it into the mouth as is the case of conventional screws. Instead, the healing cap employs resilient resistance to compression when being inserted into the opening of the implant anchor to create friction maintaining the cap in place.

While this arrangement may seem much less secure than conventional threaded engagement, the fact is that little force is actually required to secure the healing cap in the implant anchor. This is because while chewing imposes strong forces which urge the healing cap into the implant anchor, there are no corresponding forces acting to remove the healing cap from the implant anchor. Moreover, the cap is only temporarily installed, and will be subsequently removed when the abutment or post and core is firmly secured within the implant anchor.

Temporary healing caps are generally threaded and are difficult to screw into implant anchors in the posterior areas of the mouth. It is generally desirable to minimize the amount of time it takes to temporarily cover the implant anchor. One way to accomplish this is to eliminate threading conventionally employed to secure the healing cap during its temporary placement in the implant anchor.

To this end, the novel healing cap has a cylindrical head from which depend legs which resiliently compress when inserted into the opening of the implant anchor. Consequent resilient expansion creates friction which secures the healing cap in place while the implant anchor is setting in the jaw.

A single leg may be employed in lieu of the two separated legs described above, if resilient fit with the opening of the implant anchor were sufficient.

An advantage of this arrangement is that the force required to unseat the healing cap from the implant anchor is minimal. Also, the motion of removing the healing cap is quite short and economical, compared to tedious unthreading of a conventional healing cap.

The generally cylindrical head of the healing cap has an opening at its upper or top end for receiving a tool which will be employed to extract the healing cap from the implant anchor. This opening will be threaded, if it is desired to employ a threaded key to remove the healing cap. Alternatively, grooves for engaging a key, dental pick, or other tool are inscribed on the wall of the opening in the healing cap.

The cylindrical head of the healing cap is of greater diameter than that of the legs, so that the legs can penetrate the opening of the implant anchor, while the cylindrical head seals the opening of the implant anchor upon abutting the implant anchor.

Additionally, an emergence profiler surrounds the head of the cap, covering the perimeter of the cap and the perimeter of the implant anchor. The profiler prevents the regrowth of gingival tissue around the shoulder of the implant anchor so that when the prosthetic tooth is installed it will fit between the shoulder of the implant anchor and the gingival tissue, thereby presenting a natural appearance for the prosthesis. It is easily modifiable by being made of a plastic or thin walled metal.

Accordingly, it is a principal object of the invention to provide a healing cap for a dental implant anchor which penetrates the opening of the implant anchor while not threading to the implant anchor.

It is another object of the invention to provide a leg or legs engaging the implant anchor by friction arising from resilient resistance to compression upon penetrating the opening of the implant anchor.

It is a further object of the invention to enhance frictional engagement of the opening of the implant anchor by providing a flange or head disposed upon the leg or legs of the healing cap.

Still another object of the invention is to enable engagement of the healing cap by a tool which extracts the healing cap from the implant anchor by urging the healing cap upwardly without fear of dropping it.

An additional object of the invention is to seal the opening of the implant anchor upon abutment of the head of the healing cap with the implant anchor.

It is again an object of the invention to minimize the motions and effort of extracting the healing cap from the implant anchor.

Yet another object of the invention is to provide an emergence profiler surrounding the healing cap which prevents regrowth of gingival tissue around the shoulder of the implant anchor, which is easily contourable to the gingival tissue so that it prevents overgrowth of the tissue without being above it where it could come into occlusal pressure, thereby allowing the prosthetic tooth to fit between the shoulder of the implant anchor and the surrounding gingival tissue.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an environmental, perspective, exploded view of one embodiment of the invention wherein a threaded tool is employed to extract the healing cap from the implant anchor.

FIG. 2 is a cross sectional detail view of the emergence profiler of FIG. 1.

FIG. 3 is an environmental, partially cut away, perspective view of the healing cap and emergence profiler of FIG. 1, in situ.

FIG. 4 is a cross sectional detail view of the head of the healing cap of FIG. 1.

FIG. 5 is an alternate embodiment of the head of FIG. 1.

### DETAILED DESCRIPTION OF THE PREFERRED EMBODIMENTS

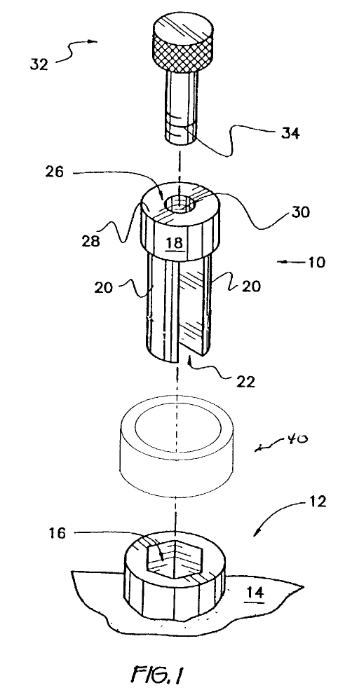

Turning now to FIG. 1 of the drawings, the novel healing cap 10 is shown above an implant anchor 12 implanted within bone tissue 14 of a patient's jaw (not separately shown). Implant anchor 12 has a conventional hexagonal opening 16 for receiving a post and core assembly (not shown) after securement of implant anchor 12 within the jaw as a result of tissue growth.

Healing cap 10 comprises a cylindrical head 18 from which depends a leg comprising two leg sections 20. Leg sections 20 are preferably complementary, separated by a slot 22 disposed therebetween, so as to collectively form a cylinder or any configuration which would cooperate with opening 16 of implant anchor 12. In this sense, cooperation signifies that when inserted into opening 16, leg sections 20 come to contact the wall of opening 16 in a generally compressive fashion, making contact at many points.

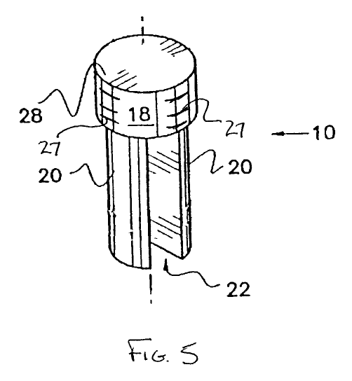

Healing cap 10 is preferably designed so that leg sections 20 are subjected to inward radial compression when inserted into opening 16. When plural leg sections 20 are provided, they will be urged towards one another during insertion. Slot 22 accommodates the slight consequent displacement of leg sections 20 as leg sections 20 approach one another during compression. Resilience of the material forming leg sections 20 causes force to be exerted against the lateral wall of opening 16 of implant anchor 12. This intimate contact causes friction maintaining healing cap 10 to remain within implant anchor 12. Optionally, leg sections 20 could have threads 24 (FIG. 5) for cooperation with a threaded implant anchor 12.

The result of this cooperation is that healing cap 10 will be upright within and axially aligned with respect to implant anchor 12. Sufficient contact between leg sections 20 and the walls of opening 16 will exist as to cause enough friction to oppose ready withdrawal of healing cap 10 from implant anchor 12.

Healing cap 10 is formed from any suitable material which is biocompatible, durable, and which possesses requisite resilience. Metals which are chemically stable within the environment of the mouth, such as titanium, and a variety of synthetic polymers are examples of such materials.

It will further be seen in this Figure that head 18 is of greater diameter than that of leg sections 20. In this embodiment, leg sections 20 are plural in number, and have a collective or effective diameter encompassing both leg sections 20. The collective diameter of leg sections 20 corresponds to and is slightly greater than the diameter of opening 16 of implant anchor 12, for assuring a frictional fit between leg sections 20 and implant anchor 12.

It would be feasible to provide any number of slots in order to form more than two leg sections 20, if desired, since such an arrangement will allow all leg sections to be displaced to the center.

Healing cap 10 is withdrawn from implant anchor 12 after healing by the following arrangement. An opening 26 is formed in the top end 28 of generally cylindrical head 18, and threads 30 are disposed upon the lateral wall of opening 26. A key or tool 32 having male threads 34 corresponding to threads 30 turns into engagement with healing cap 10, and withdraws healing cap 10 by a short upward pull. optionally, head 18 could have a plurality of horizontal grooves 27 about its perimeter (FIG. 5), grooves 27 being adapted to cooperate with a pliers type extraction tool (not shown).

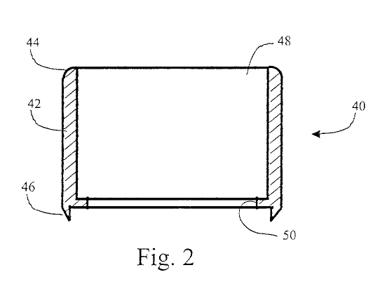

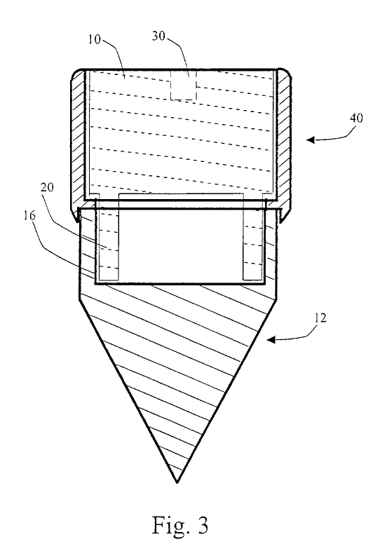

An emergence profiler 40 (FIG. 2) surrounds head 18 of healing cap 10 and the shoulder area of the implant anchor 12, as depicted in FIG. 3. Emergence profiler 40 is of a biocompatible, preferably polymeric, material which is chemically stable within the environment of the human mouth. Emergence profiler 40 has a body 42 which is substantially cylindrical externally, with a rounded upper shoulder 44 and tapered lower shoulder 46.

FIG. 2 shows the emergence profiler in cross section. The interior of body 42 has a substantially cylindrical internal bore 48 having a diameter marginally larger than that of head 18 of healing cap 10. The upper portion of internal bore 48 terminates at an internal ridge 50, internal ridge 50 protruding into the interior of the bore 48, which continues through interior ridge 50 at a marginally smaller diameter. Internal ridge 50 serves to stop head 18 of healing cap 10 from passing completely through internal bore 48 of body 42. Below internal ridge 50, the diameter of internal bore 48 is substantially equal to the upper perimeter of implant anchor 12 such that the shoulder of implant anchor 12 fits within body 40 and lower taper 46 transitions smoothly from the shoulder of implant anchor 12.

The legs 20 of a healing cap 10 being utilized with an emergence profiler 40 must be of sufficient length to pass through emergence profiler 40 and engage the interior of opening 16 of implant anchor 12, as is illustrated in FIG. 3.

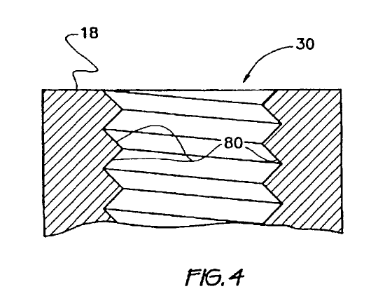

In FIG. 4, threads 30 within the head 18 of healing cap 10 seen to include a helically arranged downwardly oriented surface 80, which surface 80 is engaged by corresponding male threads 34 (see FIG. 1) of tool 32.

It will occur to those of skill in the art that the invention is susceptible to various modifications and variations. For example, leg sections 20 could be superseded by a single leg. This will be acceptable provided the superseding arrangement has resilient or elastic resistance to compression upon insertion into the implant anchor 12, or other means for enhancing engagement with its implant anchor 12. Also, still other arrangements for engaging the healing cap for removal from the implant anchor 12 may be devised.

It would be further evident to one skilled in the art that emergence profiler 40 could be adapted to cooperate with any variety of implant anchor 12 known to the art without departing from the intent of the present invention.

It would again be evident to one skilled in the art that healing cap 10 and emergence profiler 40 could be formed as a single unit, as depicted at FIG. 3.

It is to be understood that the present invention is not limited to the embodiments described above, but encompasses any and all embodiments within the scope of the following claims.

What is claimed is:

1. A healing cap and emergence profiler system for use with a dental implant anchor comprising:
sealing means for sealing the opening in a dental implant anchor having a leg which exerts outward pressure on the inside of the implant anchor to hold it in place,
extraction means for removing said sealing means from the implant anchor, and
a thin walled, contourable, profiling means for preventing the regeneration of gingival tissue around the shoulder of the implant anchor.

2. The system, as defined in claim 1, wherein said sealing means comprises a healing cap, said healing cap further comprising:
a head having a height, a circumferential dimension and a top end, said head having an engagement member formed as part of said head, said engagement member having walls and a downwardly oriented surface formed in said walls, said engagement member forming a first element of said extraction means, and said engagement member enabling a tool to engage said head for purposes of withdrawing said healing cap from the implant anchor by engaging said downwardly oriented surface by interference therewith and being pulled upwardly to remove said healing cap from said implant anchor, said tool forming a second element of said extraction means; and
a leg having means for providing resilient resistance to inward radial compression, said leg projecting downwardly from said head of said healing cap, said leg having a second circumferential dimension along its entire length of magnitude less than that of said circumferential dimension of said head of said healing cap.

3. The system, as defined in claim 1, wherein said profiling means comprises an emergence profiler having a body having an interior bore, and said body having an exterior circumference of magnitude greater than said interior bore, an interior portion, said interior portion constricting a portion of said internal bore to a magnitude less than that of said internal bore, said internal portion adapted to constrain said head fully within said internal bore while preventing said head from passing fully through said internal bore;
said legs of said healing cap adapted to extend below said constriction of said internal portion and said head adapted to engage said internal portion, thereby sealing the interior of the implant anchor from external contaminants.

4. The system, as defined in claim 1, wherein
said extraction means comprises threads formed in said downwardly oriented surface formed in said walls said top end of said head of said healing cap, and
said tool comprises a rod, said rod threaded at at least a first end, said threads adapted to engage said threads formed in said downwardly oriented surface formed in said walls for purposes of withdrawing said healing cap from the implant anchor by pulling upwardly to remove said healing cap from the implant anchor.

5. A healing cap for use with a dental implant anchor comprising;
a head having a height, a circumferential dimension and a top end, said head having an engagement member formed as part of said head, said engagement member having walls and a downwardly oriented surface formed in said walls, said engagement member enabling a tool to engage said head for purposes of withdrawing said healing cap from the implant anchor by engaging said downwardly oriented surface by interference therewith and being pulled upwardly to remove said healing cap from said implant anchor;
a leg having means for providing resilient resistance to inward radial compression, said leg projecting downwardly from said head of said healing cap.

6. A healing cap, as defined in claim 5, further comprising an emergence profiler having:
a body having an interior bore, said interior bore having a circumference adapted to receive and cooperate with said head of said healing cap, and said body having an exterior circumference of magnitude greater than said interior bore, an interior portion, said interior portion constricting a portion of said internal bore to a circumference of magnitude such that said interior portion constrains said head fully within said internal bore while preventing said head from passing fully through said internal bore;
said leg of said healing cap adapted to extend below said constriction of said internal portion and said head adapted to engage said internal portion, thereby sealing the interior of the implant anchor from external contaminants.

7. A healing cap, as defined in claim 6, wherein said emergence profiler is formed of an easily modifiable, biocompatible plastic.

8. A healing cap, as defined in claim 6, wherein said emergence profiler is formed of one of the metals from the group titanium and stainless steel.

9. A healing cap, as defined in claim 6, wherein:
said leg of said healing cap is threaded and adapted to cooperate with a threaded cavity of an implant anchor, and
said emergence profiler is of a biocompatible plastic.

10. A healing cap, as defined in claim 6, wherein said emergence profiler is formed as an integral part of said healing cap.

11. A healing cap, as defined in claim 5, wherein said engagement member is threaded to and adapted to engage a threaded tool.

12. A healing cap, as defined in claim 5, wherein said head further comprises horizontal grooves, said horizontal grooves adapted to provide grip to a pliers type extraction tool.
